(19) United States
(12) Patent Application Publication
(10) Pub. No.: US 2017/0240782 A1
(43) Pub. Date: Aug. 24, 2017

(54) OPTICALLY CLEAR ADHESIVE AND OPTICAL LAMINATE

(71) Applicant: 3M INNOVATIVE PROPERTIES COMPANY, St. Paul, MN (US)

(72) Inventors: Toshihiro Suwa, Tokyo (JP); Yusuke Nozaki, Kanagawa (JP); Shinya Nakajima, Tokyo (JP); Aya Nakada, Kanagawa (JP); Shingo Amari, Kanagawa (JP); Shunsuke Suzuki, Tokyo (JP); Chun-Yi Ting, Taoyuan Hsien (CN); Yasuhiro Kinoshita, Tokyo (JP)

(21) Appl. No.: 15/506,019

(22) PCT Filed: Aug. 26, 2015
(86) PCT No.: PCT/US2015/046881

§ 371 Date: Feb. 23, 2017

(30) Foreign Application Priority Data
Aug. 29, 2014 (JP) 2014-175736

(51) Int. Cl. C09J 133/06; G06F 3/044; B32B 7/12

(52) U.S. Cl. CPC C09J 133/066; B32B 7/12; G06F 3/044; B32B 2250/02; B32B 2255/26; B32B 2307/412; B32B 2457/208

(57) ABSTRACT

Problem: To provide an optically clear adhesive with a high dielectric constant having an excellent balance of adhesive strength and cohesive strength as well as excellent optical characteristics, and an optical laminate containing the same. Solution: The optically clear adhesive of an embodiment of the present disclosure comprises a polymer of an acrylic monomer composition containing a hydroxyl group-containing monomer and at least 0.09 mass % and less than 50 mass % of a monofunctional alkyl (meth)acrylate, wherein the number of moles of OH in 100 g of the adhesive is at least 0.3 and at most 0.90.

### TECHNICAL FIELD

The present disclosure relates to an optically clear adhesive having a high dielectric constant and an optical laminate containing the same.

### BACKGROUND

Touch panel modules contained in electronic devices such as portable mobile terminals, computer displays, and touch panels are configured from a glass or plastic cover, a touch panel, and an LCD. It is known that using an optically clear adhesive (OCA) sheet for the adhesion between these constituent parts increases transparency, reduces light scattering, and thereby yields a sharper image.

One example of an OCA is a UV-crosslinkable pressure-sensitive adhesive (PSA) sheet. A UV-crosslinkable PSA sheet provides an optical laminate which sufficiently follows the level differences or protrusions formed by printing or the like, has no external appearance defects such as unevenness, and has a moderate internal stress by applying heat and/or pressure prior to UV crosslinking.

Patent Document 1 (International Publication No. 2010/147047) describes “an optical adhesive sheet containing an adhesive layer, wherein the dielectric constant at a frequency of 1 MHz is from 2 to 8, and the dielectric loss tangent at a frequency of 1 MHz is greater than 0 and at most 0.2.”

Patent Document 2 (Japanese Unexamined Patent Application Publication No. 2012-140605) describes “an optical adhesive sheet having an adhesive layer, wherein the specific dielectric constant at a frequency of 1 MHz is from 5 to 10, and the adhesive strength with respect to glass (peeling angle: 180°, tension speed: 300 mm/min, measured 30 minutes after attached to glass) is from 3 to 15 N/20 mm.”

Patent Document 3 (Japanese Unexamined Patent Application Publication No. 2013-186808) describes “an adhesive for adhering a touch panel member containing a (meth)acrylic acid ester copolymer (A) and a crosslinking agent (B), wherein the (meth)acrylic acid ester copolymer (A) is a copolymer comprising from 19 to 92 mass % of a constituent unit (a1) derived from an alkyl (meth)acrylate monomer (a1) having an alkyl group with from 4 to 6 carbon atoms, from 7 to 80 mass % of a constituent unit (a2) derived from an alkoxyalkyl (meth)acrylate monomer (a2), and a constituent unit (a3) derived from a functional group-containing monomer (a3).”

Patent Document 4 (Japanese Unexamined Patent Application Publication No. 2012-041456) describes “an acrylic polymeric compound for use in an adhesive composition for a touch panel, which is obtained by copolymerizing (a) a (meth)acrylic acid ester monomer having a hydrocarbon group with from 1 to 12 carbon atoms, (b) a hydroxyl group-containing (meth)acrylic acid ester monomer, (c), a monomer containing an amide group, and (d) a monomer component containing a vinyl ester monomer, wherein the resin acid value is at most 0.1 mgKOH/g, the weight average molecular weight is from 400,000 to 2,000,000, the Tg is from −80 to 0°, and the dielectric constant is from 3 to 6.”

### SUMMARY

### Problem to be Solved by the Invention

In recent years, on-cell structures or in-cell structures—that is, structures having a touch sensor directly patterned on an LCD—have been used to reduce the weight and/or thickness of electrostatic capacitance type touch panel modules. One drawback of these structures is that since the distance between the touch sensor and the front panel is greater than in conventional structures, the sensitivity of the touch sensor tends to be low.

On the other hand, there are also cases in which it is desirable to use a plastic substrate such as polycarbonate (PC) or polymethyl methacrylate (PMMA) from the perspective of the weight reduction or safety of a touch panel module. However, since these substrates have a lower material dielectric constant than glass substrates, there is a risk that the sensitivity of the touch sensor may decrease.

One measures for solving these problems is to use an OCA with a high dielectric constant, but it has been difficult to achieve a high dielectric constant while maintaining the basic characteristics of the OCA—for example, a balance of the adhesive strength and cohesive strength, haze, and optical characteristics such as transmittance.

An object of the present disclosure is to provide an optically clear adhesive (OCA) with a high dielectric constant having an excellent balance of adhesive strength and cohesive strength as well as excellent optical characteristics, and an optical laminate containing the same.

### BRIEF DESCRIPTION OF THE DRAWINGS

FIG. 1 is a cross-sectional view of an optical laminate of one embodiment of the present disclosure.

### DETAILED DESCRIPTION

### Means for Solving the Problem

One embodiment of the present disclosure provides an optically clear adhesive including a polymer of an acrylic monomer composition containing a hydroxyl group-containing monomer and at least 0.09 mass % and less than 50 mass % of a monofunctional alkyl (meth)acrylate, wherein a number of moles of OH in 100 g of the adhesive is at least 0.30 and at most 0.90.

Another embodiment of the present disclosure provides an optical laminate including a first substrate having at least one main surface, a second substrate having at least one main surface, and the aforementioned optically clear adhesive disposed between the at least one main surface of the first substrate and the at least one main surface of the second substrate so as to make contact with the at least one main surface of the first substrate and the at least one main surface of the second substrate.

### Effect of the Invention

The optically clear adhesive (OCA) according to the present disclosure has multiple hydroxyl groups and therefore has a high dielectric constant. Therefore, an optical laminate using this OCA can provide a touch panel module which demonstrates high sensitivity with the same thickness as a conventional structure, and the reliability of adhesion is also high. In addition, this disclosure can provide a touch panel module with high sensitivity even when material with a low dielectric constant such as a plastic is used as a substrate.

Since the transmission wavelength can be shortened by using material with a high dielectric constant as a constituent material of an electric device, the laminate according to the present disclosure can also be advantageously used in small high-frequency circuits.

The above descriptions shall not be interpreted to disclose all of the modes of the present invention or all of the advantages of the present invention.

### Modes for Carrying Out the Invention

With the objective of illustrating representative embodiments of the present invention, the present invention will be described in further detail hereinafter with reference to the drawings, but the present invention is not limited to these embodiments.

The definitions of the terminology used in the present disclosure are as follows.

An “optically clear adhesive” refers to an adhesive having a total light transmittance of at least approximately 85% or at least approximately 90% and haze of at most approximately 5% or at most approximately 2% in the wavelength range of from 400 to 700 nm. The total light transmittance and haze can be determined in accordance with JIS K 7361-1:1997 (ISO 13468-1:1996) and JIS K 7136:2000 (ISO 14782:1999), respectively. An optically clear adhesive does not ordinarily contain visually observable air bubbles.

A “(meth)acrylic” refers to an “acrylic” or “methacrylic”, and a “(meth)acrylate” refers to an “acrylate” or “methacrylate”.

A “UV-crosslinkable site” refers to a site where a crosslink is formed with another portion in a polymer molecule or with other polymer molecules when activated by UV irradiation.

The “storage modulus” refers to the storage modulus at a designated temperature when a viscoelasticity measurement is performed in a shearing mode at a heating rate of 5° C./min and a frequency of 1 Hz in a temperature range of from −60° C. to 200° C.

The optically clear adhesive (OCA) of an embodiment of the present disclosure includes a polymer of an acrylic monomer composition containing a hydroxyl group-containing monomer and at least 0.09 mass % and less than 50 mass % of a monofunctional alkyl (meth)acrylate, wherein the number of moles of OH (hydroxyl groups) in 100 g of the adhesive is at least 0.30 and at most 0.90. The OCA exhibits a high dielectric constant due to the prescribed amount of hydroxyl groups contained in the OCA.

The optical laminate of the present disclosure can provide a touch panel module with high sensitivity since the dielectric constant of the OCA constituting the laminate is high. The optical laminate of the present disclosure is particularly advantageously used in a touch panel module that includes an on-cell or in-cell touch panel which can have a lightweight and/or thin profile.

The OCA includes a polymer of an acrylic monomer composition. The acrylic monomer composition contains a hydroxyl group-containing monomer and a monofunctional alkyl (meth)acrylate.

The hydroxyl group-containing monomer imparts a high dielectric constant to the OCA due to hydroxyl groups of high polarity. In addition, the hydroxyl group-containing monomer also adjusts the modulus of elasticity of the polymer, which also contributes to ensuring wettability with respect to the adherend. A hydroxyl group-containing monomer ordinarily has a hydroxyl group (OH group) equivalent of at most approximately 600, at most approximately 400, or at most approximately 200. The hydroxyl group equivalent is defined as a value obtained by dividing the molecular weight of the monomer by the number of hydroxyl groups contained in the monomer. Examples of useful hydroxyl group-containing monomers include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexane dimethanol mono(meth)acrylate, 1-glycerol (meth)acrylate, 2-hydroxyethyl (meth)acrylamide, N-hydroxypropyl (meth)acrylamide, vinyl alcohol, and allyl alcohol. It is also possible to use a hydroxyl group-containing monomer using a poly(alkylene) glycol obtained from ethylene oxide or propylene oxide as a base. Examples of hydroxyl group-containing monomers of this type include polyethylene glycol mono(meth)acrylate and polypropylene glycol mono(meth)acrylate using a hydroxyl group as a terminal group, such as Blemmer (trademark) AE200 (n≈4.5, NOF Corporation), Bisomer (trademark) PPA 6 (GEO Specialty Chemicals UK Ltd., United Kingdom), and the like, for example. The hydroxyl group-containing monomer may be used alone, or two or more types may be used in combination.

Of these hydroxyl group-containing monomers, hydroxyalkl (meth)acrylates in which the number of carbon atoms of alcohol residues is from 2 to 4—for example, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and 1-glycerol (meth)acrylate—can be used advantageously because the dielectric constant of the OCA can be increased more effectively, and 2-hydroxyethyl acrylate, 2-hydroxypropyl acrylate, 3-hydroxypropyl acrylate, 2-hydroxybutyl acrylate, and 4-hydroxybutyl acrylate, which have even high polymerizability, can be particularly advantageously used.

In some embodiments, the acrylic monomer composition contains over approximately 50 mass % of a hydroxyl group-containing monomer. In several embodiments, the acrylic monomer composition contains the hydroxyl group-containing monomer in an amount of at least approximately 51 mass %, at least approximately 53 mass %, or at least approximately 55 mass % and at most approximately 99.9 mass %, at most approximately 80 mass %, or at most approximately 65 mass %. The dielectric constant of the OCA can be further increased by setting the amount of the hydroxyl group-containing monomer that is used to within the ranges described above.

A monofunctional alkyl (meth)acrylate is an alkyl (meth)acrylate having one acryloyl group or methacryloyl group. The monofunctional alkyl (meth)acrylate imparts the OCA with the viscoelastic characteristics (wettability, cohesive strength, and the like) required for adhesiveness or pressure adhesiveness and also contributes to ensuring the weather resistance of the OCA. A (meth)acrylate of a non-tertiary alcohol in which the alkyl group has from 2 to 12 carbon atoms can be used as a monofunctional alkyl (meth)acrylate. Examples of such monofunctional alkyl (meth)acrylates include but are not limited to ethyl (meth)acrylate, n-butyl (meth)acrylate, isobutyl (meth)acrylate, isoamyl (meth)acrylate, n-hexyl (meth)acrylate, n-octyl (meth)acrylate, 2-ethylhexyl (meth)acrylate, isooctyl (meth)acrylate, isononyl (meth)acrylate, n-decyl (meth)acrylate, isodecyl (meth)acrylate, 2-propylheptyl acrylate, n-dodecyl (meth)acrylate, 2-methylbutyl (meth)acrylate, 4-methyl-2-pentyl (meth)acrylate, 4-t-butylcyclohexyl (meth)acrylate, cyclohexyl (meth)acrylate, isobornyl (meth)acrylate, and the like. The monofunctional alkyl (meth)acrylate may be used alone, or two or more types may be used in combination.

Monofunctional alkyl (meth)acrylates having straight-chained alkyl groups with from 4 to 12 carbon atoms such as n-butyl (meth)acrylate, n-hexyl (meth)acrylate, n-octyl (meth)acrylate, n-decyl (meth)acrylate, and n-dodecyl (meth)acrylate, for example, reduce the glass transition temperature Tg of the OCA, so using these monofunctional alkyl (meth)acrylates makes it possible to introduce many hydroxyl groups into the OCA and to achieve suitable viscoelastic characteristics. In addition, the dipole moment is high since the molar volume is small in comparison to monofunctional alkyl (meth)acrylates having branched alkyl groups with the same number of carbon atoms. Therefore, an OCA having a higher dielectric constant can be obtained. On the other hand, monofunctional alkyl (meth)acrylates having branched alkyl groups or alicyclic alkyl groups such as 2-ethylhexyl (meth)acrylate and isobornyl (meth)acrylate, for example, increase the glass transition temperature of the OCA in comparison to monofunctional alkyl (meth)acrylates having straight-chain alkyl groups with the same number of carbon atoms, so using these monofunctional alkyl (meth)acrylates makes it possible to obtain an OCA having a cohesive strength suited to the application and the temperature environment used. The monofunctional alkyl (meth)acrylate may be used alone, or two or more types of monofunctional alkyl (meth)acrylates may be used in combination in accordance with the desired characteristics.

The acrylic monomer composition contains the monofunctional alkyl (meth)acrylate in an amount of at least approximately 0.09 mass % and less than approximately 50 mass %. In several embodiments, the acrylic monomer composition contains the monofunctional alkyl (meth)acrylate in an amount of at least approximately 0.09 mass %, at least approximately 20 mass %, or at least approximately 40 mass %. In several embodiments, the acrylic monomer composition contains the monofunctional alkyl (meth)acrylate in an amount of at most approximately 49 mass %, at most approximately 40 mass %, or at most approximately 30 mass %. By setting the amount of the monofunctional alkyl (meth)acrylate to less than approximately 50 mass % of the acrylic monomer composition, it is possible to sufficiently secure the adhesive strength of the OCA, and by setting the amount to at least approximately 0.09 mass %, the modulus of elasticity of the OCA can be set to an appropriate range, and the wettability of the OCA with respect to the adherend can be improved, and it is thus possible to impart the OCA with excellent weather resistance, which contributes to reliability.

In some embodiments, the acrylic monomer composition further contains an alkoxyalkyl (meth)acrylate, which adjusts the viscoelastic characteristics of the OCA while also contributing to an increase in the dielectric constant. The alkoxyalkyl (meth)acrylate may be used alone, or two or more types may be used in combination.

A (meth)acrylate of a non-tertiary alcohol in which the alkoxyalkyl group has from 2 to 12 carbon atoms can be used as the alkoxyalkyl (meth)acrylate. Examples of such alkoxyalkyl (meth)acrylates include 2-methoxyethyl (meth)acrylate, 2-ethoxyethyl (meth)acrylate, 3-methoxypropyl (meth)acrylate, 3-ethoxypropyl (meth)acrylate, 4-methoxybutyl (meth)acrylate, and 4-ethoxybutyl (meth)acrylate. Of these alkoxyalkyl (meth)acrylates, alkoxyalkyl acrylates can be used advantageously from the perspective of reactivity, and 2-methoxyethyl acrylate can be particularly advantageously used from the perspective that an OCA having a high dielectric constant can be obtained.

A poly(alkyleneoxy) (meth)acrylate represented by the following formula (1):

CH₂═C(R¹)COO—(R²O)ₙ—R³ (1)

(in formula (1), R¹ is hydrogen or a methyl group; R² is a group selected from a group including an ethylene group, a propylene group, and butylene group, and combinations thereof; R³ is a straight-chain, branched, or alicyclic alkyl group having from 2 to 12 carbon atoms; and n is an integer of at least 2 and at most 10) can also be used as an alkoxyalkyl (meth)acrylate. Examples of such (alkyleneoxy) (meth)acrylates include 2-(2-ethoxyethoxy)ethyl (meth)acrylate, methoxy triethylene glycol (meth)acrylate, and 2-ethylhexyl diethylene glycol (meth)acrylate (available as EHDG-AT from Kyoeisha Chemical Co., Ltd. (Osaka, Japan), for example).

In embodiments using an alkoxyalkyl (meth)acrylate, the acrylic monomer composition contains the alkoxyalkyl (meth)acrylate in an amount of at least approximately 5 mass %, at least approximately 10 mass %, or at least approximately 20 mass % and at most approximately 50 mass %, at most approximately 25 mass %, or at most approximately 10 mass %. By setting the amount of the alkoxyalkyl (meth)acrylate that is used to within the ranges described above, it is possible to obtain an OCA which achieves viscoelastic characteristics (cohesive strength, wettability, and the like) suitable for the OCA while having a high dielectric constant. In applications in which high weather resistance is required, it is more advantageous for the amount of the alkoxyalkyl (meth)acrylate that is used to be relatively small, and the amount is preferably at most approximately 10 mass %, at most approximately 7.5 mass %, or at most approximately 5 mass %, for example. In applications in which such a high weather resistance is required, the amount of the alkoxyalkyl (meth)acrylate that is used may be at least approximately 0.1 mass %, at least approximately 5 mass %, or at least approximately 7.5 at least approximately.

The acrylic monomer composition may contain a crosslinking agent such as a polyfunctional monomer or a (meth)acrylate having a UV-crosslinkable site for the purpose of increasing the curability of the composition, the cohesive strength of the OCA, or the like. In some embodiments, using a (meth)acrylate having a UV-crosslinkable site makes it possible to obtain a UV-crosslinkable OCA which can be deformed by applying heat and/or pressure so as to follow the surface shape of the adherend.

Examples of polyfunctional monomers include difunctional (meth)acrylates such as 1,10-decanediol di(meth)acrylate, 1,6-hexanediol di(meth)acrylate, 1,4-butanediol di(meth)acrylate, tricyclodecane dimethylol di(meth)acrylate, (poly)ethylene glycol di(meth)acrylate, (poly)propylene glycol di(meth)acrylate, neopentyl glycol di(meth)acrylate, and pentaerythritol di(meth)acrylate; trifunctional or higher (meth)acrylates such as pentaerythritol tri(methacrylate), dipentaerythritol hexa(meth)acrylate, trimethylolpropane tri(meth)acrylate, and tetramethylolmethane tri(meth)acrylate; allyl (meth)acrylate, vinyl (meth)acrylate, divinyl benzene, epoxy acrylate, polyester acrylate, urethane acrylate, and the like. The polyfunctional monomer may be used alone, or two or more types may be used in combination.

A (meth)acrylate having a site where a crosslink with other portions in the polymer molecule is formed or a crosslink is formed with other copolymer molecules when activated by UV irradiation in the molecule can be used as a (meth)acrylate having a UV-crosslinkable site. For example, a structure which is excited by UV irradiation so as to extract hydrogen radicals from other portions in the polymer molecule or from other polymer molecules can be used as a UV-crosslinkable site, and examples of such a structure include a benzophenone structure, a benzyl structure, an o-benzoyl benzoic acid ester structure, a thioxanthone structure, a 3-ketocoumarin structure, a 2-ethylanthraquinone structure, a camphorquinone structure, and the like.

Of the structures described above, a benzophenone structure is advantageous from the perspectives of transparency, reactivity, and the like. Examples of (meth)acrylates having such a benzophenone structure include 4-acryloyloxy benzophenone, 4-acryloyloxy ethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxy benzophenone, 4-methacryloyloxyethoxy benzophenone, 4-methacryloyloxy-4′-methoxybenzophenone, 4-methacryloyloxyethoxy-4′-methoxybenzophenone, 4-methacryloyloxy-4′-bromobenzophenone, 4-methacryloyloxyethoxy-4′-bromobenzophenone, and the like. The (meth)acrylate having a UV-crosslinkable site can be used alone, or two or more types may be used in combination.

In embodiments using crosslinking agent such as a polyfunctional monomer or a (meth)acrylate having a UV-crosslinkable site, the acrylic monomer composition contains the crosslinking agent in an amount of at least approximately 0.1 mass %, at least approximately 1 mass %, or at least approximately 2 mass % and at most approximately 10 mass %, at most approximately 5 mass %, or at most approximately 3 mass %. By setting the amount of the crosslinking agent that is used to within the ranges described above, it is possible to achieve viscoelastic characteristics (cohesive strength, wettability, and the like) suitable for the OCA.

The acrylic monomer composition may contain a chain-transfer agent or a retarder capable of imparting the OCA with the desired viscoelastic characteristics by controlling the molecular weight and content of the polymer. Examples of such chain-transfer agents include halogenated hydrocarbons such as carbon tetrabromide or carbon tetrachloride and sulfur-containing compounds such as isooctyl thioglycolate, dodecanethiol, butylmercaptane, tert-dodecylmercaptane, 2-mercaptoethanol, 1-mercapto-2-propanol, 3-mercapto-1-propanol, p-mercaptophenol, and the like. Examples of retarders include α-methylstyrene dimers, quinones such as o-, m-, or p-benzoquinones, nitro compounds such as nitrobenzene, o-, m-, or p-dinitrobenzene, and 2,4-dinitro-6-chlorobenzene, amines such as diphenylamine, catechol derivatives such as tertiary butylcatechol, and 1,1-diphenylethylene, and the like. These chain-transfer agents and retarders may be used alone, or two or more types may be used in combination. Retarders and chain-transfer agents may also be used in combination.

In embodiments using a chain-transfer agent, the acrylic monomer composition contains the chain-transfer agent in an amount of at least approximately 0.1 mass %, at least approximately 0.5 mass %, or at least approximately 1 mass % and at most approximately 5 mass %, at most approximately 3 mass %, or at most approximately 2 mass %. In embodiments using a retarder, the acrylic monomer composition contains the retarder in an amount of at least approximately 0.05 mass %, at least approximately 0.25 mass %, or at least approximately 0.5 mass % and at most approximately 5 mass %, at most approximately 3 mass %, or at most approximately 2 mass %.

Acrylic monomer compositions typically contain a thermal initiator or a photoinitiator. Examples of thermal initiators include peroxides such as benzoyl peroxide and t-butyl perbenzoate and azo compounds such as 2,2′-azobis isobutyronitrile, 2,2′-azobis-(2-methylbutyronitrile), and 2,2′-azobis(2,4-dimethylvaleronitrile). Examples of photoinitiators include 1-hydroxycyclohexylphenylketone, 2,2-dimethoxy-2-phenylacetophenone, 2-methyl-1-[4-(methylthio)phenyl]-2-morpholinopropane-1-one, 2-hydroxy-2-methyl-1-phenylpropane-1-one, 2-benzyl-2-dimethylamino-1-(4-morpholinophenyl)-butane-1-one, 1-[4-(2-hydroxyethoxy)-phenyl]-2-hydroxy-2-methyl-1-propane-1-one, 2,4,6-trimethylbenzoyldiphenylphosphineoxide, 2,6-dimethylbenzoyldiphenylphosphineoxide, benzoyldiethoxyphosphineoxide, bis(2,6-dimethoxybenzoyl)-2,4,4-trimethylpentylphosphineoxide, benzoin alkyl ethers (for example, benzoin methyl ether, benzoin ethyl ether, benzoin isopropyl ether, benzoin isobutyl ether, n-butylbenzoin ether, and the like), 1-(4-isopropylphenyl)-2-hydroxy-2-methylpropane-1-one, 2-hydroxy-2-methyl-1-phenylpropane-1-one, p-tert-butyltrichloroacetophenone, p-tert-butyldichloroacetophenone, benzyl, acetophenone, thioxanthones (2-chlorothioxanthone, 2-methylthioxanthone, 2,4-diethylthioxanthone, and 2,4-diisopropylthioxanthone), camphorquinones, 3-ketocoumarin, anthraquinones (for example, anthraquinone, 2-ethylanthraquinone, α-chloroanthraquinone, 2-tert-butylanthraquinone, and the like), acenaphthene, 4,4′-dimethoxybenzyl, 4,4′-dichlorobenzyl, and the like. Examples of commercially available photoinitiators include photoinitiators sold under the trade names Irgacure and Darocur from BASF and Velsicure from Velsicol Chemical Corporation. The thermal initiator and the photoinitiator may be used singly or as a combination of two or more types.

The acrylic monomer composition may also contain a polar group-containing monomer other than the hydroxy-group containing monomer and the alkoxyalkyl (methacrylate) as an optional component. The polar group-containing monomer contains polar groups such as carboxyl groups, amide groups, and amino groups and can be used to adjust the cohesive force of the OCA, for example. Examples of such polar group-containing monomers include carboxyl group-containing monomers such as (meth)acrylic acids, itaconic acid, maleic acid, fumaric acid, crotonic acid, and isocrotonic acid and anhydrides thereof (maleic anhydride and the like); amide group-containing monomers such as N-vinylcaprolactam, N-vinylpyrrolidone, (meth)acrylamide, N-methyl (meth)acrylamide, N,N-dimethyl (meth)acrylamide, and N-octyl (meth)acrylamide; and amino group-containing monomers such as N,N-dimethylaminoethyl (meth)acrylate, N,N-diethylaminoethyl (meth)acrylate, and N,N-dimethylaminoethyl (meth)acrylamide.

The acrylic monomer composition may also contain other monomers as optional components as long as they do not substantially diminish the characteristics of the OCA. Examples of such monomers include (meth)acrylic compounds other than those described above such as tetrahydrofurfuryl (meth)acrylate, olefins such as ethylene, butadiene, isoprene, and isobutylene, and vinyl monomers such as vinyl acetate, vinyl propionate, and styrene.

In embodiments using polar group-containing monomers or other monomers, the acrylic monomer composition contains each of the components thereof in an amount of at least approximately 0.1 mass %, at least approximately 1 mass %, or at least approximately 5 mass % and at most approximately 25 mass %, at most approximately 15 mass %, or at most approximately 10 mass % for each component, and when a plurality of components are used, the acrylic monomer composition contains the components in a total amount of at least approximately 0.2 mass %, at least approximately 1 mass %, or at least approximately 5 mass % and at most approximately 25 mass %, at most approximately 15 mass %, or at most approximately 10 mass %.

The OCA can be formed by polymerization using the heating of the acrylic monomer composition or the radiation exposure of the composition to UV rays or an electron beam. A partial polymer may be formed by performing partial polymerization through heating or radiation exposure before adding a crosslinking agent, a chain-transfer agent, and/or a retarder to the acrylic monomer composition. A crosslinking agent, a chain-transfer agent, a retarder, and/or an additional thermal initiator or photoinitiator is added to the acrylic monomer composition containing the partial polymer, and after the resulting composition is coated onto a liner subjected to a release treatment such as a silicone coating, the OCA can be formed by curing (or crosslinking) through heating or radiation exposure. Alternatively, both polymerization and curing may be performed in a single step by adding a crosslinking agent, a chain-transfer agent, and/or a retarder to the acrylic monomer composition from the start.

The acrylic monomer composition which contains or does not contain a partial polymer can be coated using a known coating technique such as roller coating, spray coating, knife coating, or die coating. Alternatively, the acrylic monomer composition may be supplied as a liquid so as to fill a gap between two substrates, and the composition may then be polymerized and cured by heating or radiation exposure.

The polymer of the acrylic monomer composition may be a hydroxyl group-containing acrylic polymer having a weight average molecular weight of at least 100,000. The value of the weight average molecular weight is measured by gel permeation chromatography (GPC) and is converted to a value in terms of polystyrene. In some embodiments, the weight average molecular weight of the hydroxy group-containing acrylic polymer is at least 100,000, at least 500,000, or at least 1,000,000. By setting the weight average molecular weight to at least 100,000, it is possible to express sufficient cohesive strength and adhesive strength.

The OCA may contain a hydroxyl group-containing acrylic oligomer having a weight average molecular weight of at least 1,000 and at most 60,000. The value of the weight average molecular weight is measured by gel permeation chromatography and is converted to a value in terms of polystyrene. In some embodiments, the weight average molecular weight of the hydroxyl group-containing acrylic oligomer is at least 1,000 or at least 5,000 and at most 60,000, at most 50,000 or at most 30,000. By setting the weight average molecular weight to at least 1,000, it is possible to maintain long-term reliability. By setting the weight average molecular weight to at most 60,000 it is possible to effectively increase the dielectric constant (specific dielectric constant) in comparison to when a hydroxyl group-containing acrylic oligomer is not contained. The miscibility with the polymer is also obtained. The hydroxyl group-containing acrylic oligomer may be formed in the same manner as a hydroxyl group-containing acrylic polymer. In addition, it may also be formed with an aqueous system such as aqueous solution polymerization or emulsion polymerization. In any case, the weight average molecular weight can be adjusted by adjusting the polymerization conditions. In some embodiments, the OCA contains the hydroxyl group-containing acrylic oligomer in an amount of at least 5 mass %, at least 10 mass %, or at least 20 mass % and at most 40 mass %, at most 30 mass %, or at most 20 mass. By containing the oligomer in an amount of at least 5 mass %, it is possible to obtain an OCA with a higher dielectric constant comparing with an OCA which does not contain the oligomer. In addition, by adding components with a comparatively low molecular weight, it is possible to improve the flowability of the OCA (or, in the case of a crosslinkable OCA, it is possible to improve the flowability of the OCA prior to crosslinking), so there is also the merit that the level difference filling properties or resistance to color irregularity can be improved. Further, a di(meth)acrylate is, in general, also contained as an impurity in the hydroxyl group-containing monomer in an amount, for example, of at least 0.1 mass % or at least 0.5 mass %, but by adding an oligomer for which polymerization has been completed in advance, it is possible to obtain an OCA in which unintended crosslinking due to the effects of impurities is restrained.

An OCA is typically formed into a sheet shape. The thickness of the OCA sheet can be determined appropriately in accordance with the application and may be set, for example, to at least approximately 5 μm and at most approximately 1 mm. One criterion for determining the thickness of the OCA sheet is the height of level differences or protrusions on the surface of the adherend. When the height of the level differences or protrusions on the surface of the adherend are determined along the perpendicular direction (thickness direction of the OCA sheet) with respect to the width plane of the OCA sheet applied to the adherend, the thickness of the OCA sheet can be set to at least approximately 0.8 times, at least approximately 1 time, or at least approximately 1.2 times and at most approximately 5 times, at most approximately 3 times, or at most approximately 2 times the maximum height of the level differences or protrusions. By setting the thickness to such a range, it is possible to suppress the thickness of a laminate containing the adherend to a thin level, and as a result, it is possible to achieve an improvement in the sensitivity of the touch panel sensor, and a reduction in the size or profile of the image display device, or the like.

The number of moles of OH in 100 g of the OCA is at least approximately 0.30 and at most approximately 0.90. In some embodiments, the number of moles of OH in 100 g of the OCA is at least approximately 0.40 or at least approximately 0.50 and at most approximately 0.80 or at most approximately 0.70. By setting the number of moles of OH in 100 g of the OCA to at least approximately 0.30, it is possible to achieve a high dielectric constant, and by setting the number of moles to at most approximately 0.90, it is possible to realize highly reliable adhesion. The number of moles of OH in 100 g of the OCA is a number calculated by the following formula. That is, it is the total of the numbers of moles of OH of various hydroxyl group-containing monomers contained in 100 g of the OCA.

### Formula 2:

$$Number of moles of OH in 100 g of OCA = {\sum }_{n = 1 \text{∼} i}^{ } \frac{{W}_{i}}{{M}_{i}} \times {N}_{i}$$

W₁, W₂, . . . , Wᵢ: mass of hydroxyl group-containing monomers 1, 2, . . . , i in 100 g of the OCA
M₁, M₂, . . . , Mᵢ: molecular weight of hydroxyl group-containing monomers 1, 2, . . . , i
N₁, N₂, . . . , Nᵢ: number of hydroxyl groups contained in hydroxyl group-containing monomers 1, 2, . . . , i

The OCA of some embodiments is a pressure-sensitive adhesive. A tackifier may be added to the OCA as necessary. Examples of tackifiers include rosin ester resins, aromatic hydrocarbon resins, aliphatic hydrocarbon resins, and terpene resins.

Known additives such as polyfunctional isocyanate, crosslinking promoters such as aziridine and epoxy compounds, anti-aging agents, fillers, colorants (pigments, dyes, and the like), UV absorbers, antioxidants, plasticizers, and nanofillers may also be contained in the OCA as long as they do not substantially diminish the characteristics of the OCA.

The OCA of some embodiments is nonaqueous. “Nonaqueous” means that the OCA is not formed from an acrylic monomer composition of an aqueous solution or an emulsion. A nonaqueous OCA typically does not contain surfactants—in particular, anionic, cationic, and amphoteric surfactants—and is therefore advantageous for increasing the in-plane uniformity of the dielectric constant when formed into a sheet shape. Preferably the OCA can be formed by bulk polymerization.

The dielectric constant of the OCA in some embodiments is at least approximately 8.0, at least approximately 8.5, or at least approximately 9.0 and at most approximately 20, at most approximately 15, or at most approximately 13 at a frequency of 100 kHz. For example, when applied to an electrostatic capacitance type touch panel—in particular, an on-cell or in-cell touch panel—setting the dielectric constant of the OCA to at least approximately 8.0 makes it possible to achieve a sufficient level of sensor sensitivity and operational stability, and setting the dielectric constant to at most approximately 20 makes it possible to efficiently utilize the electrical energy required to drive the touch panel. In the present disclosure, the “dielectric constant” refers to the “specific dielectric constant ∈_{R} (=∈/∈_{O})”, which is the ratio of the dielectric constant ∈ of the OCA and the dielectric constant ∈_{O} of a vacuum. The dielectric constant is a value measured under conditions at 25° C. and a frequency of 100 kHz in accordance with JIS K 6911:1995.

The storage modulus G′ of the OCA in some embodiments is at least approximately 1×10³ Pa or at least approximately 1×10⁴ Pa and at most approximately 5×10⁶ Pa or at most approximately 5×10⁵ Pa at 25° C. and 1 Hz. An OCA having a storage modulus within the ranges described above has an excellent balance of cohesive strength and adhesive strength. The storage modulus of the OCA can be adjusted by appropriately adjusting the types, molecular weights, and compounding ratios of monomers constituting the polymer contained in the OCA as well as the degree of polymerization of the polymer.

An optical laminate of another embodiment of the present disclosure includes a first substrate having at least one main surface, a second substrate having at least one main surface, and the aforementioned optically clear adhesive disposed between the at least one main surface of the first substrate and the at least one main surface of the second substrate so as to make contact with the at least one main surface of the first substrate and the at least one main surface of the second substrate.

The first substrate may be various optical films such as a surface protection film, an antireflective (AR) film, a polarizer, a phase difference plate, an optical compensation film, a brightness-improving film, a light guide, or a transparent conductive film (such as an ITO film). Examples of the first substrate include polycarbonates, polyesters (for example, polyethylene terephthalate and polyethylene naphthalate), polyurethanes, poly(meth)acrylates (for example, polymethyl methacrylate), polyvinyl alcohols, polyolefins (for example, polyethylene and polypropylene), triacetyl cellulose, polymers such as cyclic olefin polymers, and substances produced from glass. The first substrate may be an optically clear substrate. An “optically clear substrate” refers to a substrate having a total light transmittance of at least approximately 85% or at least approximately 90% and haze of at most approximately 5% or at most approximately 2% within a wavelength range of from 400 to 700 nm. The total light transmittance and haze can be determined in accordance with JIS K 7361-1:1997 (ISO 13468-1:1996) and JIS K 7136:2000 (ISO 14782:1999), respectively.

The second substrate may be the same substance as described for the first substrate and may be a liquid crystal display, an OLED display, a touch panel or touch panel module, an electrowetting display or cathode-ray tube, electronic paper, a window, a glazing, or the like. In some embodiments, the second substrate is an electrostatic capacitance-type touch panel—in particular, an on-cell or in-cell touch panel—and an OCA with a high dielectric constant contributes to an improvement in the sensor sensitivity and operational stability of these touch panels.

The thicknesses of the first and second substrates described above are not particularly limited. When the substrate is a film or has a sheet shape, the thickness of the substrate may be set to at least approximately 50 μm, at least approximately 500 μm, or at least approximately 1 mm, for example, and the thickness of the substrate may be set to at most approximately 5 mm, at most approximately 500 μm, or at most approximately 100 μm. The substrate surface making contact with the OCA may be subjected to physical treatment such as corona discharge or plasma treatment or to a chemical treatment such as a primer.

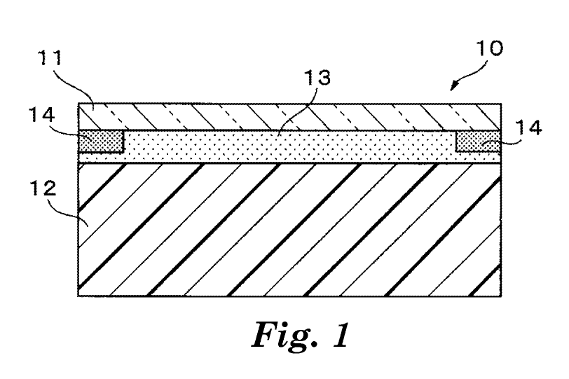

A cross-sectional view of the optical laminate of an embodiment of the present disclosure is illustrated in FIG. 1. An optical laminate 10 includes a first substrate 11, a second substrate 12, and an optically clear adhesive (OCA) 13 disposed between the main surface of the first substrate 11 and the main surface of the second substrate 12 so as to make contact with these main surfaces. The OCA 13 has a shape of an adhesive sheet which can be attached to the main surface of the first substrate 11, for example. The optical laminate 10 can be obtained, for example, by attaching a laminate including the first substrate 11 and the OCA 13 to the main surface of the second substrate 12—for example, the display screen of an on-cell or in-cell touch panel.

In FIG. 1, a light shielding layer 14 provided in a partial region of the lower surface of the first substrate 11 is shown, and this light shielding layer 14 forms level differences or protrusions on the substrate surface. The light shielding layer 14 can be formed, for example, by applying a liquid, which is prepared by mixing a colorant into a coating solution of a curable resin composition, to a prescribed region of the first substrate 11 with an appropriate method such as screen printing, and curing the liquid with an appropriate curing method such as UV irradiation.

In the optical laminate 10 illustrated in FIG. 1, the OCA 13 makes contact with the surface of the first substrate 11 having the light shielding layer 14 which forms level differences or protrusions, and it follows these level differences or protrusions, so the vicinity of the light shielding layer 14 is filled by the adhesive sheet and a vacant space not formed.

Such a laminate can be produced, for example, by a method including: a step of obtaining a UV-crosslinkable OCA sheet by using an acrylic monomer composition containing a (meth)acrylate having a UV-crosslinkable site and performing polymerization and curing as necessary under conditions in which the UV-crosslinkable site is not activated; a step of arranging the UV-crosslinkable OCA sheet adjacent to a first substrate on the f surface side having level differences or protrusions; a step of arranging a second substrate adjacent to the UV-crosslinkable OCA sheet; a step of heating and/or applying pressure to the UV-crosslinkable OCA sheet so that is follows the level differences or protrusions; and a step of crosslinking the UV-crosslinkable OCA sheet by irradiating the sheet with UV rays. These steps can be performed in various orders.

The UV-crosslinkable OCA sheet has sufficient fluidity to follow the level differences or protrusions when heated and/or pressurized. For example, the storage modulus of the OCA contained in the OCA sheet prior to UV crosslinking is at least approximately 5.0×10⁴ Pa and at most approximately 1.0×10⁶ Pa at 30° C. and 1 Hz and at most approximately 5.0×10⁴ Pa at 80° C. and 1 Hz, and the storage modulus of the OCA after UV crosslinking is at least approximately 1.0×10³ Pa at 130° C. and 1 Hz. Since the OCA has such viscoelastic characteristics, applying heat and/or pressure after attaching the OCA sheet to an adherend at a normal operating temperature makes it possible for the UV-crosslinkable OCA sheet to follow the level differences, protrusions, or the like on the surface of a surface protection layer, for example. Performing UV crosslinking thereafter increases the cohesive strength of the OCA sheet and makes it possible to realize highly reliable adhesion.

The heating step can be performed using a convection oven, a hot plate, a heat laminator, an autoclave, or the like, and it is advantageous to apply pressure simultaneously with heating using a heat laminator, an autoclave, or the like. Pressurization using an autoclave is particularly advantageous for removing bubbles from the OCA sheet. The heating temperature of the OCA sheet should be a temperature at which the OCA sheet softens or flows so as to sufficiently follow the level differences or protrusions, and it is typically set to at least approximately 30° C., at least approximately 40° C., or at least approximately 60° C. and at most approximately 150° C., at most approximately 120° C., or at most approximately 100° C. When the OCA sheet is pressurized, the pressure that is applied can typically be set to at least approximately 0.05 MPa or at least approximately 0.1 MPa and at most approximately 2 MPa or at most approximately 1 MPa.

The UV irradiation step can be performed using a typical UV irradiation apparatus such as a belt conveyor type UV irradiation apparatus, for example, which uses a low-pressure mercury lamp, a medium-pressure mercury lamp, a high-pressure mercury lamp, an ultrahigh-pressure mercury lamp, a xenon lamp, a metal halide lamp, an electrodeless lamp, an LED lamp, or the like as a light source. The amount of UV irradiation is typically from approximately 1,000 mJ/cm² to approximately 5,000 mJ/cm².

Yet another embodiment of the present disclosure provides an electronic device containing the optical laminate described above. Examples of such an electronic device include but are not limited to a mobile telephone, a personal digital assistant (PDA), a mobile game console, an electronic reading terminal, a car navigation system, a mobile music player, a clock, a television (TV), a video camera, a video player, a digital camera, a global positioning system (GPS) device, and a personal computer (PC).

### Examples

In the following working examples, specific embodiments of the present disclosure are illustrated, but the present invention is not limited to these examples. Unless specified otherwise, all parts and percentages are based on mass.

The materials used in the working examples are shown in Table 1.

TABLE 1

| | Trade Name or | |
|---|---|---|
| Type | Abbreviation | |
| Hydroxyl group- | HEA | 2-Hydroxyethyl acrylate |
| containing monomers | 4 HBA | 4-Hydroxybutyl acrylate |
| | 2 HPA | 2-Hydroxypropyl acrylate |
| | CHDMMA | 1,4-Cyclohexanedimethanol |
| | | monoacrylate, available from |
| | | Nippon Kasei Chemical Co. Ltr. |
| | | (Chuo-ku, Tokyo, Japan) |
| | HEMA | 2-Hydroxyethyl methacrylate |
| | Blemmer (trademark) | 1-Gylcerol methacrylate, available |
| | GLM | from the NOF Corporation |
| | | (Shibuya-ku, Tokyo, Japan) |
| | Blemmer (trademark) | Polyethylene glycol monoacrylate, |
| | AE200 | available from NOF Corporation |
| | | (Shibuya-ku, Tokyo, Japan) |
| | Bisomer (trademark) | Polypropylene glycol monoacrylate, |
| | PPA6 | available from GEO Specialty |
| | | Chemicals UK Ltd. (South |
| | | Hampton, UK) |
| Monofunctional alkyl | BA | n-Butyl acrylate |
| (meth)acrylates | HA | n-Hexyl acrylate |
| | NOA | n-Octyl acrylate |
| | 2EHA | 2-Ethylhexyl acrylate |
| | 2EHMA | 2-Ethylhexyl methacrylate |
| | IBXA | Isobornyl acrylate |
| | IBXMA | Isobornyl methacrylate |
| Alkoxyalkyl | EEEA | 2-(2-Ethoxyethoxy)ethyl acrylate |
| (meth)acrylates | MEA | 2-Methoxyethyl acrylate |
| Other monomers | THF-A | Tetrahydrofurfuryl acrylate |
| | AA | Acrylic acid |
| | AcAm | Acrylamide |
| Crosslinking monomers | ABP | 4-Acryloyloxybenzophenone |
| | HDDA | 1,6-Hexanediol diacrylate |
| Chain-transfer agent | IOTG | Isooctyl thiogylcolate |
| | t-DDM | t-Dodecyl mercaptan |
| Photoinitiator | Irgacure (registered | 1-Hydroxycycloheylphenylketone, |
| | trademark) 184 | available from BASF Japan Co., |
| | | Ltd. (Minato-ku, Japan) |

### Preparation of Oligomer

Acrylic oligomer was prepared as follows. A mixture of 4HBA/NOA/AcAm equaling 60/37/3 (parts by mass) was prepared and diluted with a mixed solvent of methyl ethyl ketone/iso-propyl alcohol (MEK/IPA=50 mass %/50 mass %) to form a monomer concentration of 30 mass %. A thermal initiator, 2,2′-Azobis(2, 4-dimethylvaleronitrile), was added as an initiator in a ratio of 0.2 mass % based on monomer components and the system was nitrogen-purged for 10 minutes. Subsequently, the reaction was allowed to proceed in a constant temperature bath at 25° C. for 24 hours. As a result, a transparent viscous solution was obtained. This polymerization solution was coated on silicone-coated film and dried in an oven at 80° C. for 7 minutes. Then, dried oligomer (Oligomer-1) was obtained. The weight average molecular weight of the oligomer was 22,000 (in terms of polystyrene by gel permeation chromatography).

Another oligomer (Oligomer-2) was obtained in a similar manner described above expect that a mixture of 4HBA/NOA/AcAm equaling 60/37/3 (parts by mass) was diluted with MEK to form a monomer concentration of 25 mass %. The weight average molecular weight of the oligomer was 49,000.

### Preparation of OCA Sheet

Of the monomer components shown in Tables 2, 3, and 4, the monomers other than the crosslinking agents (ABP and HDDA) and the chain-transfer agent (IOTG), and 0.15 parts by mass of Irgacure (registered trademark) 184 were used to prepare a premix. The monomer premix was partially polymerized by exposing it to UV rays in a nitrogen-rich atmosphere, and a coatable syrup having a viscosity of approximately 2 Pa·s (2,000 cP) was obtained.

Next, 0.5 parts by mass of Irgacure (registered trademark) 184 and the remaining monomers (crosslinking agent and chain-transfer agent) or oligomers, when used, were added and mixed into the syrup, and bubbles were removed.

The obtained viscous mixture was knife-coated with a thickness of 100 μm between two silicone-treated release liners. Next, the resulting coating material was exposed to low-intensity UV rays (total energy: 1,200 mJ/cm²) having a maximum spectrum output of from 300 to 400 nm at 351 nm so as to obtain an OCA sheet.

### Specific Dielectric Constant Measurement

The specific dielectric constant ∈ᵣ of the OCA was measured under conditions including a temperature of 25° C. and a frequency of 100 kHz in accordance with JIS K 6911:1995.

### Number of Moles of OH in 100 g of OCA

The number of moles of OH in 100 g of the OCA was calculated using the following formula. In addition, additives such as a thermal initiator, a photoinitiator, a crosslinking agent, a chain-transfer agent, and a retarder or modified products thereof were also contained in 100 g of the OCA.

### Formula 2:

$$Number of moles of OH in 100 g of OCA = {\sum }_{n = 1 \text{∼} i}^{ } \frac{{W}_{i}}{{M}_{i}} \times {N}_{i}$$

W₁, W₂, . . . , Wᵢ: mass of hydroxyl group-containing monomers 1, 2, . . . , i in 100 g of the OCA
M₁, M₂, . . . , Mᵢ: molecular weight of hydroxyl group-containing monomers 1, 2, . . . , i
N₁, N₂, . . . , Nᵢ: number of hydroxyl groups contained in hydroxyl group-containing monomers 1, 2, . . . , i

### Total Light Transmittance and Haze Measurement

The OCA sheet was laminated on a float glass substrate (80 mm×55 mm×0.7 mm) using a rubber roller. Next, a separate float glass substrate (80 mm×55 mm×0.7 mm) and an OCA/glass laminate were attached to one another using a vacuum attachment processing device (made by Takatori Co., Ltd., trade name: TPL-0209MH). The attachment conditions included a degree of vacuum of 100 Pa, a laminate pressure of 0.225 MPa, and a laminate time of 5 seconds. The glass/OCA/glass laminate was then treated in an autoclave (0.5 MPa, 25° C., 15 minutes).

The total light transmittance and haze of the resulting glass/OCA/glass laminate were measured using a haze meter NDH2000 (Nippon Denshoku Industries Co., Ltd.) in accordance with JIS K 7361-1:1997 and JIS K 7136:2000, respectively.

### Printed Level Difference Filling Property

Printed level difference filling was performed using a float glass substrate (80 mm×55 mm×0.7 mm) having a printed frame. The printed region expanded inward with a width of approximately 6 mm from the outer peripheral edge of one side of the substrate. The level difference of the printed region was approximately 28 μm.

The OCA sheet was laminated on a float glass substrate (80 mm×55 mm×0.7 mm) using a rubber roller. Next, the surface of the float glass substrate on the printed region side and the OCA/glass laminate were attached to one another using a vacuum attachment processing device (made by Takatori Co., Ltd., trade name: TPL-0209MH). The attachment conditions included a degree of vacuum of 100 Pa, a laminate pressure of 0.225 MPa, and a laminate time of 5 seconds. The resulting laminate was then placed in an oven for 30 minutes at 65° C. After the laminate was removed from the oven and left to stand for 30 minutes at room temperature, the laminate was treated with an autoclave (0.5 MPa, 25° C., 15 minutes).

The obtained laminate was irradiated with UV rays using a UVX-02528S1XK01 (Ushio Inc.) equipped with a metal halide lamp UVL-7000M4-N (120 W/cm). The total amount of irradiation measured using a UV POWER PUCK (registered trademark) II (EIT Inc.) was set to 2,000 mJ/cm² for UV-A (320 to 390 nm). The external appearance of the laminate after UV irradiation was examined visually for the presence or absence of defects such as bubbles or detachment.

### Viscoelastic Characteristics

The viscoelastic characteristics of the OCA sheet before and after UV crosslinking were measured using a dynamic viscoelasticity measuring device ARES (TA Instruments, Inc.). For samples prior to UV crosslinking, the OCA sheet was laminated to a thickness of 2 mm and punched out with a diameter of 8 mm to form a sample. For samples after UV crosslinking, the OCA sheet prior to UV crosslinking was irradiated with UV rays using a UVX-02528S1XK01 (Ushio Inc.) equipped with a metal halide lamp UVL-7000M4-N (120 W/cm). The total amount of irradiation measured using a UV POWER PUCK (registered trademark) II (EIT Inc.) was set to 2,000 mJ/cm² for UV-A (320 to 390 nm). The OCA sheet was then laminated to a thickness of 2 mm and punched out with a diameter of 8 mm to form a sample. The measurement conditions included a shearing mode at a frequency of 1 Hz, a temperature range of from −60° C. to 200° C., and a heating rate of 5° C./minute, and the storage modulus (G′) was recorded at 25° C., 30° C., and 80° C. for samples prior to UV crosslinking and at 130° C. after UV crosslinking.

The evaluation results of the OCA sheets and laminates are shown in Tables 2 and 3.

TABLE 2
(Numerical values related to monomer components represent parts by mass)

| Monomer | | | | | | | | | | | |
|---|---|---|---|---|---|---|---|---|---|---|---|
| Component | Example 1 | Example 2 | Example 3 | Example 4 | Example 5 | Example 6 | Example 7 | Example 8 | Example 9 | Example 10 | Example 11 |
| HEA | 49.9 | 69.9 | 69.9 | 52.5 | 60.0 | | | | | | 52.5 |
| 4HBA | 40.0 | 30.0 | | | | 60.0 | 51.0 | 40.0 | 40.0 | 40.0 | |
| 2HPA | | | 30.0 | | | | | | | | |
| CHDMMA | | | | | | | | 11.0 | | | |
| HEMA | 10.0 | | | | | | | | | | |
| GLM | | | | | | | | | | | |
| AE200 | | | | | | | | | 11.0 | | |
| PPA6 | | | | | | | | | | 11.0 | |
| BA | 0.10 | | | | 40.0 | 40.0 | 49.0 | 49.0 | 49.0 | 49.0 | |
| HA | | | | | | | | | | | |
| NOA | | 0.10 | 0.10 | 1.0 | | | | | | | 47.5 |
| 2EHA | | | | | | | | | | | |
| 2EHMA | | | | | | | | | | | |
| IBXA | | | | | | | | | | | |
| IBXMA | | | | | | | | | | | |
| EEEA | | | | | | | | | | | |
| MEA | | | | 46.5 | | | | | | | |
| THF-A | | | | | | | | | | | |
| AA | | | | | | | | | | | |
| AcAm | | | | | | | | | | | |
| ABP | | | | 0.2 | 0.2 | 0.1 | 0.1 | 0.1 | | | |
| HDDA | 0.1 | 0.1 | 0.1 | | | 0.1 | 0.1 | 0.1 | 0.1 | 0.1 | 0.1 |
| Specific | 13.3 | 14.5 | 13.4 | 12.6 | 10.5 | 10.3 | 9.4 | 8.9 | 9.4 | 8.8 | 8.7 |
| dielectric | | | | | | | | | | | |
| constant εᵣ | | | | | | | | | | | |
| (100 kHz, | | | | | | | | | | | |
| 25° C.) | | | | | | | | | | | |
| Number of | 0.778 | 0.804 | 0.827 | 0.448 | 0.512 | 0.413 | 0.351 | 0.330 | 0.316 | 0.301 | 0.449 |
| moles of OH | | | | | | | | | | | |
| (mol/100 g) | | | | | | | | | | | |

| Monomer | | | | | |
|---|---|---|---|---|---|
| Component | Example 12 | Example 13 | Example 14 | Example 15 | Example 16 |
| HEA | | | 20.0 | 20.0 | 20.0 |
| 4HBA | 55.0 | 55.0 | 32.5 | 30.0 | 35.0 |
| 2HPA | | | | | |
| CHDMMA | | | | | |
| HEMA | | | | 5.0 | |
| GLM | | | | 20.0 | 5.0 |
| AE200 | | | | | |
| PPA6 | | | | | |
| BA | | | | | |
| HA | | 45.0 | | | |
| NOA | 45.0 | | 35.0 | | |
| 2EHA | | | | | |
| 2EHMA | | | | | |
| IBXA | | | | 0.5 | |
| IBXMA | | | | | 0.5 |
| EEEA | | | | 19.5 | 19.5 |
| MEA | | | 10.0 | | |
| THF-A | | | | | 20.0 |
| AA | | | | 5.0 | |
| AcAm | | | 2.5 | | |
| ABP | 0.1 | | 0.3 | 0.1 | 0.1 |
| HDDA | 0.1 | 0.1 | | | |
| Specific dielectric | 8.7 | 9.2 | 8.2 | 11.1 | 12.6 |
| constant εᵣ | | | | | |
| (100 kHz, 25° C.) | | | | | |
| Number of moles | 0.378 | 0.379 | 0.394 | 0.664 | 0.474 |
| of OH (mol/100 g) | | | | | |

| Monomer | Comparative | Comparative | Comparative | Comparative | Comparative | Comparative | Comparative | Comparative | Comparative |
|---|---|---|---|---|---|---|---|---|---|
| Component | Example 1 | Example 2 | Example 3 | Example 4 | Example 5 | Example 6 | Example 7 | Example 8 | Example 9 |
| HEA | | 30.0 | 14.0 | | | | | | 20.0 |
| 4HBA | | | | 40.0 | 42.5 | | | 30.0 | |
| 2HPA | | | | | | | | | |
| CHDMMA | | | | | | | | | |
| HEMA | | | | | | | | | |
| GLM | | | | | | | | | |
| AE200 | | | | | | | | | |
| PPA6 | | | | | | | | | |
| BA | | | | | | 40.0 | | | |
| HA | | | | | | | | | |
| NOA | 47.5 | 70.0 | | 60.0 | 57.5 | | 40.0 | 51.0 | 61.0 |
| 2EHA | | | 65.0 | | | | | | |
| 2EHMA | | | 18.0 | | | | | | |
| IBXA | | | | | | | | | |
| IBXMA | | | | | | | | 4.0 | 4.0 |
| EEEA | | | | | | | | | |
| MEA | 52.5 | | | | | 60.0 | 60.0 | 7.5 | 7.5 |
| THF-A | | | | | | | | 7.5 | 7.5 |
| AA | | | | | | | | | |
| AcAm | | | 3.0 | | | | | | |
| ABP | | | 0.2 | 0.1 | 0.1 | 0.2 | 0.2 | 0.2 | 0.2 |
| HDDA | 0.1 | 0.1 | 0.06 | 0.06 | 0.06 | 0.1 | 0.1 | | 0.3 |
| Specific dielectric | 6.4 | 6.3 | 4.6 | 7.1 | 7.3 | 7.5 | 6.7 | 7.9 | 6.3 |
| constant εᵣ | | | | | | | | | |
| (100 kHz, 25° C.) | | | | | | | | | |
| Number of moles | 0.000 | 0.256 | 0.119 | 0.275 | 0.292 | 0.000 | 0.000 | 0.207 | 0.170 |
| of OH (mol/100 g) | | | | | | | | | |

TABLE 3
(Numerical values related to monomer components represent parts by mass)

| Monomer Component | Example 5 | Example 17 | Example 4 | Example 18 | Example 14 | Example 19 |
|---|---|---|---|---|---|---|
| HEA | 60.0 | 60.0 | 52.5 | 52.5 | 20.0 | 20.0 |
| 4HBA | | | | | 32.5 | 32.5 |
| 2HPA | | | | | | |
| CHDMMA | | | | | | |
| HEMA | | | | | | |
| GLM | | | | | | |
| AE200 | | | | | | |
| PPA6 | | | | | | |
| BA | 40.0 | 40.0 | | | | |
| HA | | | | | | |
| NOA | | | 1.0 | 1.0 | 35.0 | 35.0 |
| 2EHA | | | | | | |
| 2EHMA | | | | | | |
| IBXA | | | | | | |
| IBXMA | | | | | | |
| EEEA | | | | | | |
| MEA | | | 46.5 | 46.5 | 10.0 | 10.0 |
| THF-A | | | | | | |
| AA | | | | | | |
| AcAm | | | | | 2.5 | 2.5 |
| ABP | 0.2 | 0.2 | 0.2 | 0.2 | 0.3 | 0.3 |
| HDDA | | | | | | |
| IOTG | | 0.4 | | 0.6 | | 0.5 |
| Specific dielectric constant εᵣ | 10.5 | 10.9 | 12.6 | 13.1 | 8.2 | 8.4 |
| (100 kHz, 25° C.) | | | | | | |
| Number of moles of OH (mol/100 g) | 0.512 | 0.510 | 0.448 | 0.446 | 0.394 | 0.392 |
| Total light transmittance (%) | 91.3 | 91.3 | 91.3 | 91.3 | 91.2 | 91.2 |
| Haze (%) | 0.1 | 0.1 | 0.1 | 0.1 | 0.1 | 0.1 |
| | | | Air | | | |
| | Air bubbles | | bubbles | | Air bubble | |
| Printing level difference filling property | present | No defects | present | No defects | present | No defects |
| Storage modulus G′ before UV | 8.1 × 10⁴ | 1.2 × 10⁵ | 1.5 × 10⁵ | 8.8 × 10⁵ | 2.7 × 10⁵ | 8.5 × 10⁴ |
| crosslinking (1 Hz, 25° C.) | | | | | | |
| Storage modulus G′ before UV | 7.6 × 10⁴ | 9.6 × 10⁴ | 1.4 × 10⁵ | 7.5 × 10⁴ | 2.4 × 10⁵ | 7.1 × 10⁴ |
| crosslinking (1 Hz, 30° C.) | | | | | | |
| Storage modulus G′ before UV | 5.8 × 10⁴ | 1.6 × 10⁴ | 1.3 × 10⁵ | 1.3 × 10⁴ | 8.8 × 10⁴ | 1.6 × 10⁴ |
| crosslinking (1 Hz, 80° C.) | | | | | | |
| Storage modulus G′ after UV | N.A. | 5.3 × 10³ | N.A. | 9.0 × 10³ | N.A. | 9.4 × 10³ |
| crosslinking (1 Hz, 130° C.) | | | | | | |

TABLE 4
(Numerical values related to monomer components represent parts by mass)

| Monomer Component | Example 20 | Example 21 | Example 22 | Example 23 |
|---|---|---|---|---|
| HEA | | | | |
| 4HBA | 44 | 55 | 60.4 | 50.5 |
| 2HPA | | | | |
| CHDMMA | | | | |
| HEMA | | | | |
| GLM | | | | |
| AE200 | | | | |
| PPA6 | | | | |
| BA | | | | |
| NOA | 29.5 | 29.5 | 32.6 | 26.0 |
| HA | | | | |
| 2EHA | | | | |
| 2EHMA | | | | |
| IBXA | | | | |
| IBXMA | | | | |
| EEEA | | | | |
| MEA | 4 | 4 | 4.5 | 3.5 |
| THF-A | | | | |
| AA | | | | |
| AcAm | 2.5 | 2.5 | 2.5 | 2.0 |
| ABP | | 0.1 | | |
| HDDA | 0.1 | | 0.1 | 0.1 |
| Oligomer-1 | 20 | | | 18.0 |
| Oligomer-2 | | 9 | | |
| IOTG | | | | |
| t-DDM | 0.5 | 0.5 | 0.5 | 0.5 |
| Specific dielectric constant εᵣ | 10.5 | 10.3 | 10.1 | 10.6 |
| (100 kHz, 25° C.) | | | | |
| Number of moles of OH (mol/100 g) | 0.384 | 0.414 | 0.414 | 0.419 |
| Total light transmittance (%) | 91.0 | 91.0 | 91.4 | 91.0 |
| Haze (%) | 0.2 | 0.2 | 0.2 | 0.1 |
| Printing level difference filling | No defects | No defects | No defects | No defects |
| property | | | | |
| Storage modulus G′ before UV | N.A. | 6.1 × 10⁴ | N.A. | N.A. |
| crosslinking (1 Hz, 25° C.) | | | | |
| Storage modulus G′ before UV | N.A. | 5.1 × 10⁴ | N.A. | N.A. |
| crosslinking (1 Hz, 30° C.) | | | | |
| Storage modulus G′ before UV | N.A. | 1.1 × 10⁴ | N.A. | N.A. |
| crosslinking (1 Hz, 80° C.) | | | | |
| Storage modulus G′ after UV | N.A. | 4.6 × 10³ | N.A. | N.A. |
| crosslinking (1 Hz, 130° C.) | | | | |

1. An optically clear adhesive comprising a polymer of an acrylic monomer composition containing a hydroxyl group-containing monomer and at least 0.09 mass % and less than 50 mass % of a monofunctional alkyl (meth)acrylate, a number of moles of OH in 100 g of the adhesive being at least 0.30 and at most 0.90.

2. The optically clear adhesive according to claim 1, wherein the acrylic monomer composition contains more than 50 mass % of the hydroxyl group-containing monomer.

3. The optically clear adhesive according to claim 1, wherein the optically clear adhesive contains a hydroxyl group-containing acrylic oligomer having a molecular weight of at least 1,000 and at most 60,000.

4. The optically clear adhesive according to claim 1, wherein the adhesive is nonaqueous.

5. The optically clear adhesive according to claim 1, wherein a dielectric constant of the adhesive is at least 8.0 at 100 kHz.

6. The optically clear adhesive according to claim 1, wherein the acrylic monomer composition further contains an alkoxyalkyl (meth)acrylate.

7. The optically clear adhesive according to claim 1, wherein the monofunctional alkyl (meth)acrylate has a straight-chain alkyl group with from 4 to 12 carbon atoms.

8. The optically clear adhesive according to claim 1, wherein a storage modulus G′ of the adhesive is at least 1×10³ Pa and at most 5×10⁶ Pa at 25° C. and 1 Hz.

9. The optically clear adhesive according to claim 1, wherein the adhesive is UV-crosslinkable; the storage modulus G′ of the adhesive before UV crosslinking is at least 5×10⁴ Pa and at most 1.0×10⁶ Pa at 30° C. and 1 Hz and at most 5.0×10⁴ Pa at 80° C. and 1 Hz; and the storage modulus of the adhesive after UV crosslinking is at least 1.0×10³ Pa at 130° C. and 1 Hz.

10. An optical laminate comprising:
a first substrate having at least one main surface;
a second substrate having at least one main surface; and
the optically clear adhesive according to claim disposed between the at least one main surface of the first substrate and the at least one main surface of the second substrate so as to make contact with the at least one main surface of the first substrate and the at least one main surface of the second substrate.

11. The optical laminate according to claim 10, wherein the second substrate is an electrostatic capacitance-type touch panel.

12. The optical laminate according to claim 11, wherein the electrostatic capacitance-type touch panel is an on-cell or in-cell touch panel.
